(19) United States
(12) Patent Application Publication
(10) Pub. No.: US 2006/0028544 A1
(43) Pub. Date: Feb. 9, 2006

(54) Electronic blind guidance cane

(76) Inventor: Mei-Chuan Tseng, Changhua Hsien (TW)

Correspondence Address: RABIN & BERDO, P.C., Suite 500, 1101 14th Street, N.W., Washington, DC, 20005, US

(21) Appl. No.: 10/912,339

(22) Filed: Aug. 6, 2004

(51) Int. Cl. H04N 7/18; H04N 9/47

(52) U.S. Cl. 348/62

(57) ABSTRACT

An electronic blind guidance cane comprised of a handle, a cane member, an electric eye system, and a cordless earphone. The handle body consists of a hollow enclosure and a cover, the enclosure capable of containing the electric eye sensing system which consists a printed circuit board as well as solid sensing electric eyes, a liquid sensing electric eye, a power switch, a battery, and a vibration inductor wired to it. Given the structure of the present invention, the electric eye system is capable of prompting the output of a warning sound or vibration whenever a solid or a liquid obstruction is encountered within a zone of safety to thereby facilitate the distinguishing of the obstruction.

### BACKGROUND OF THE INVENTION

1) Field of the Invention

The invention herein relates to an electronic blind guidance cane in which the blind guidance cane handle body contains an electric eye sensing system, the electric eye sensing system consisting of solid sensing electric eyes and a liquid sensing electric eye capable of prompting the output of a warning sound or vibration whenever a solid or a liquid obstruction is encountered within a zone of safety, enabling the blind person to distinguish and, furthermore, have greater warning safety.

2) Description of the Prior Art

Currently available walking canes utilized by the blind typically have the following drawbacks: 1) Their ultrasonic wave processing circuit board only has an ultrasonic wave transmitter and an ultrasonic wave receiver, and since the cane only provides for undirectional induction and the user must move the cane numerous times to determine whether an obstruction is present, the utilization operation is complicated and inconvenient. 2) Since the ultrasonic wave processing circuit board ultrasonic wave transmitter and ultrasonic wave receiver only provides for sensing solid obstructions and is incapable of sensing liquid obstructions (such as a water puddle, drainage ditch, or pond, etc.), utilization is hazardous.

In view of the said shortcomings, the applicant of the invention herein conceived of a thoughtful and original idea based on many years of design experience and extensive investigation that, following repeated sample testing and numerous refinements, culminated in the introduction of the invention herein.

### SUMMARY OF THE INVENTION

The primary objective of the invention herein is to provide an electronic blind guidance cane in which the blind guidance cane handle body contains an electric eye sensing system, a solid sensing electric eyes and a liquid sensing electric eye such that when a solid obstruction or a liquid obstruction is encountered within the zone of safety, the electric eye system is capable of prompting the output of a warning sound from a buzzer or a cordless earphone to thereby enable greater warning safety.

Another objective of the invention herein is to provide an electronic blind guidance cane in which when a blind person uses the blind guidance cane and a solid obstruction or a liquid obstruction is encountered within the zone of safety, and the proximity of the obstruction becomes closer, the outputted warning sound and frequency varies, enabling the blind person to distinguish and, furthermore, have greater warning safety.

Yet another objective of the invention herein is to provide an electronic blind guidance cane in which when a blind person having impaired hearing utilizes the blind guidance cane and a solid obstruction or a liquid obstruction is encountered within the zone of safety, and the proximity of the obstruction becomes closer, the handle generates vibration at varying frequencies enabling the blind person to distinguish and, furthermore, have greater warning safety.

### BRIEF DESCRIPTION OF THE DRAWINGS

FIG. 1 is an exploded drawing of the invention herein.

FIG. 1A is an cordless earphone of the invention herein.

FIG. 2 is an isometric drawing of the invention herein.

FIG. 3 is a block diagram of the electric eye sensing system circuit of the invention herein.

FIG. 4 is an orthographic drawing of the invention herein that illustrates it use and operation.

FIG. 5 is a drawing of the invention herein that illustrates it use and operation.

FIG. 6 is a drawing of the invention herein that illustrates it use and operation.

FIG. 7 is a drawing of the invention herein that illustrates it use and operation.

FIG. 8 is a drawing of another embodiment of the invention herein.

FIG. 9 is a drawing of yet another embodiment of the invention herein.

### DETAILED DESCRIPTION OF THE INVENTION

The brief description of the drawings are accompanied below by the detailed description of the present invention.

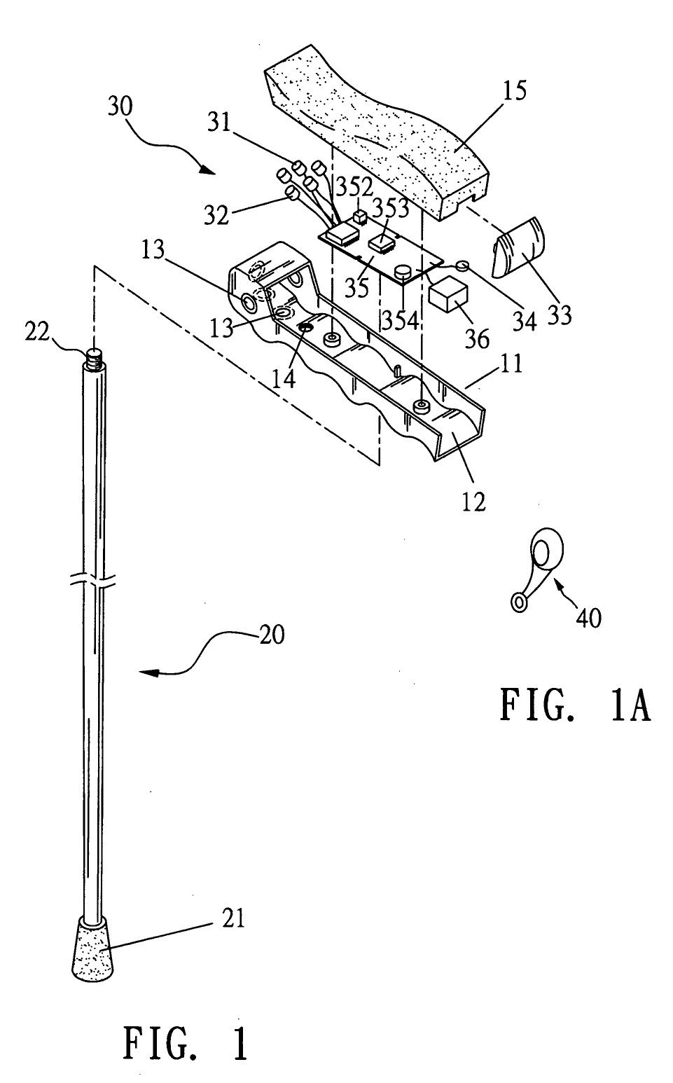

The blind guidance cane (referring to FIG. 1) is comprised of a handle 10, a cane member 20, an electric eye sensing system 30, and a cordless earphone 40; the handle 10 handle body 11 consists of a hollow enclosure 12, a cover 16 attached to the upper extent, through-holes 13 in the peripheral surfaces of one end, and a threaded hole 14 in the lower extent; the cane member 20 is a long rod-like construct having a non-slip cushion 21 sleeved onto one extremity and a threaded stud 22 projecting from the other extremity; the electric eye sensing system 30 consists of four solid sensing electric eyes 31, a liquid sensing electric eye 32, a power switch 33, a battery 34, and a vibration inductor 36 wired to a printed circuit board 35, the printed circuit board 35 having a signal transceiver 351, a microprocessor 352, a voice IC 353, and a buzzer 354 disposed on it.

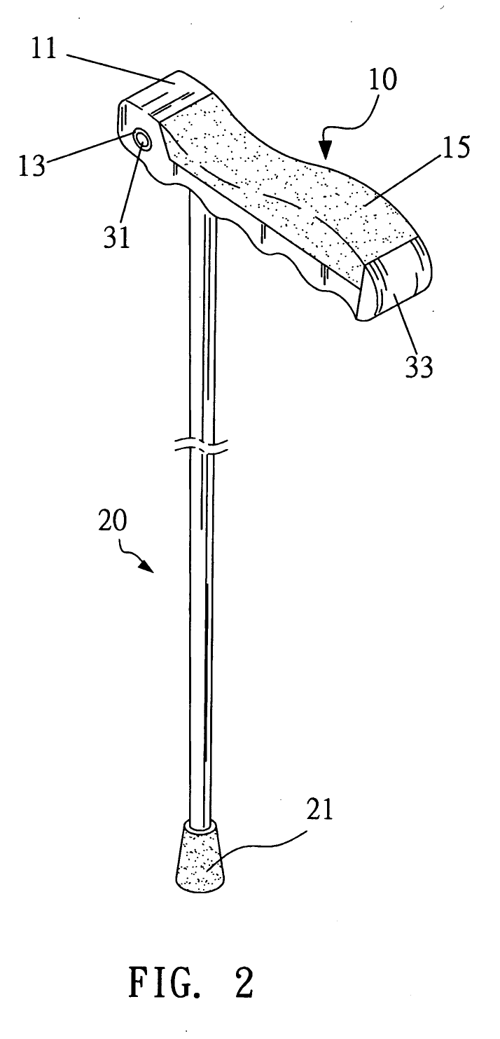

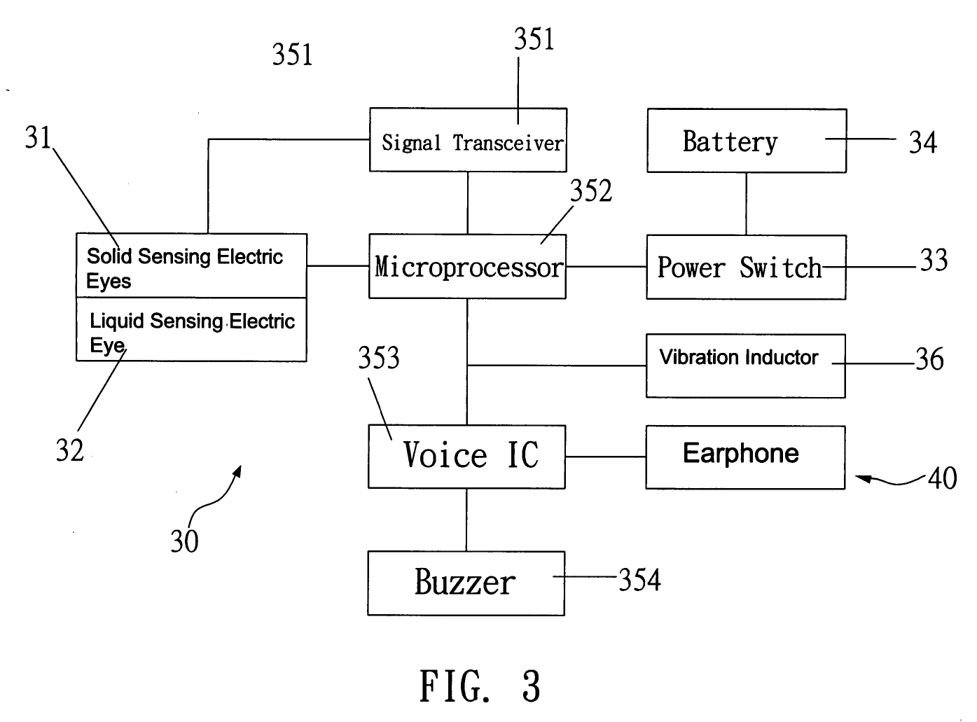

When the blind guidance cane of the invention herein is assembled (referring to FIG. 2 and FIG. 3), the electric eye sensing system 30 printed circuit board 35, the battery 34, and the vibration inductor 36 are contained in the handle body 11 enclosure 12, the solid sensing electric eyes 31 are respectively mounted in the through-holes 13 at the left, right, front, and bottom extents of the handle body 11, the liquid sensing electric eye 32 is mounted in another through-hole 13 at the lower extent of the handle body 11, and the cover 15 is situated over the enclosure 12, following which the cane member 20 threaded stud 22 is fastened into the threaded hole 14 at the lower extent of the handle body 1, which thereby completes assembly.

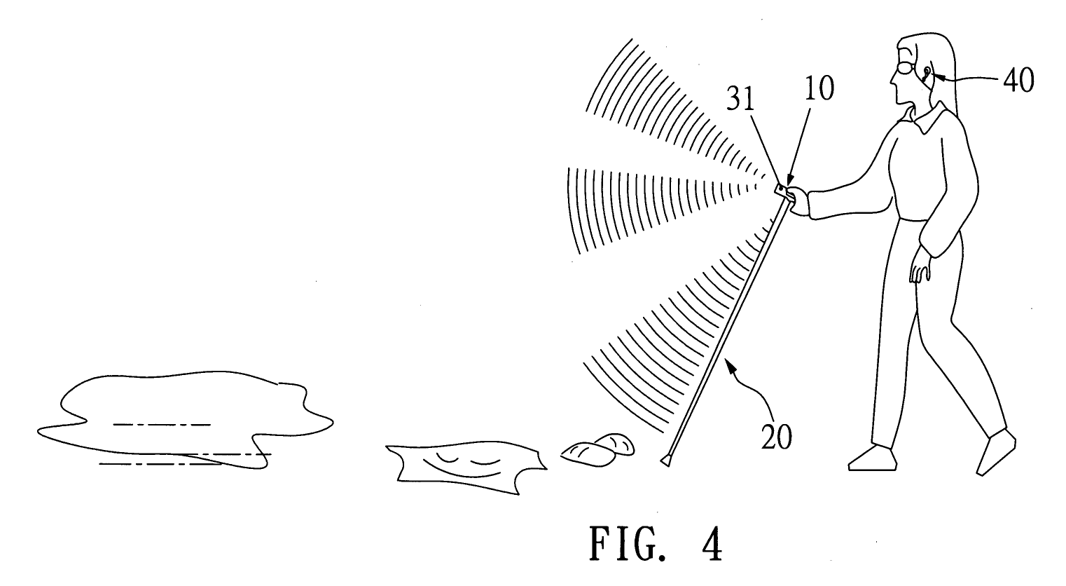

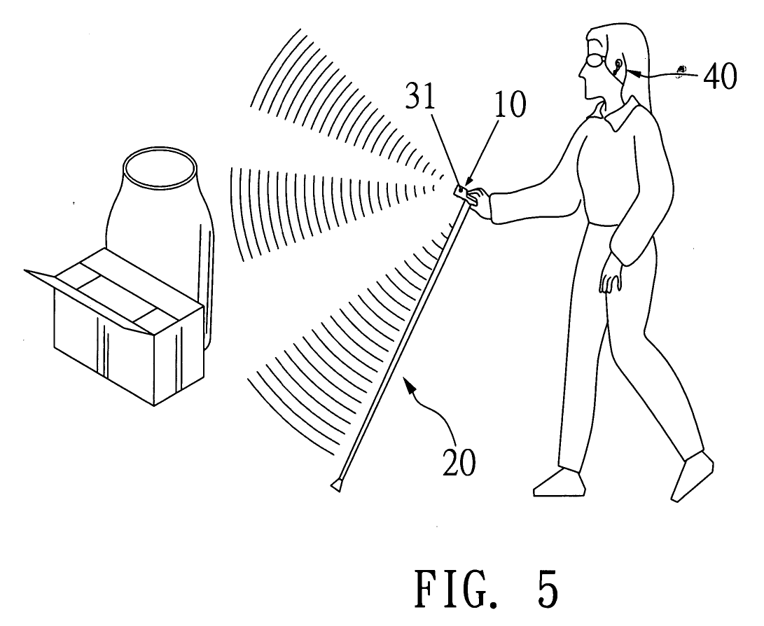

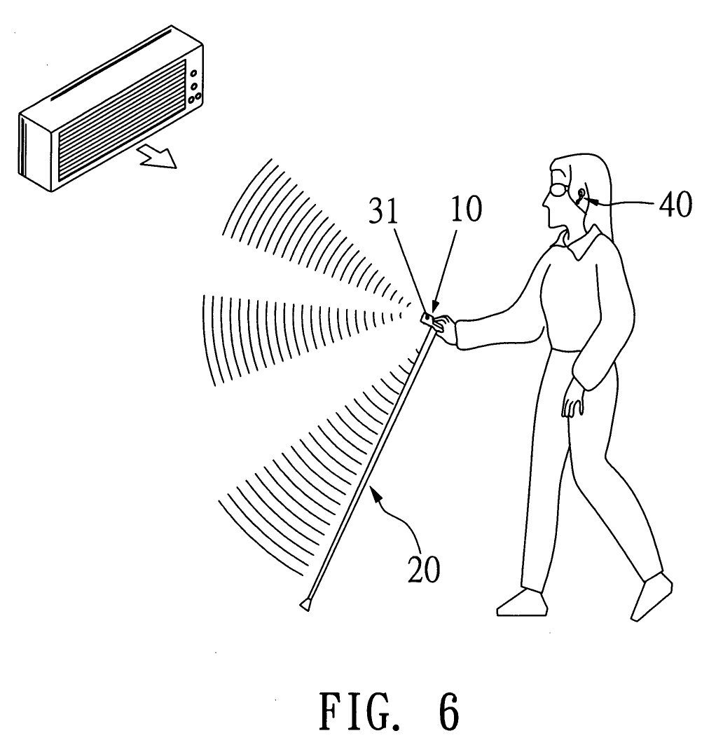

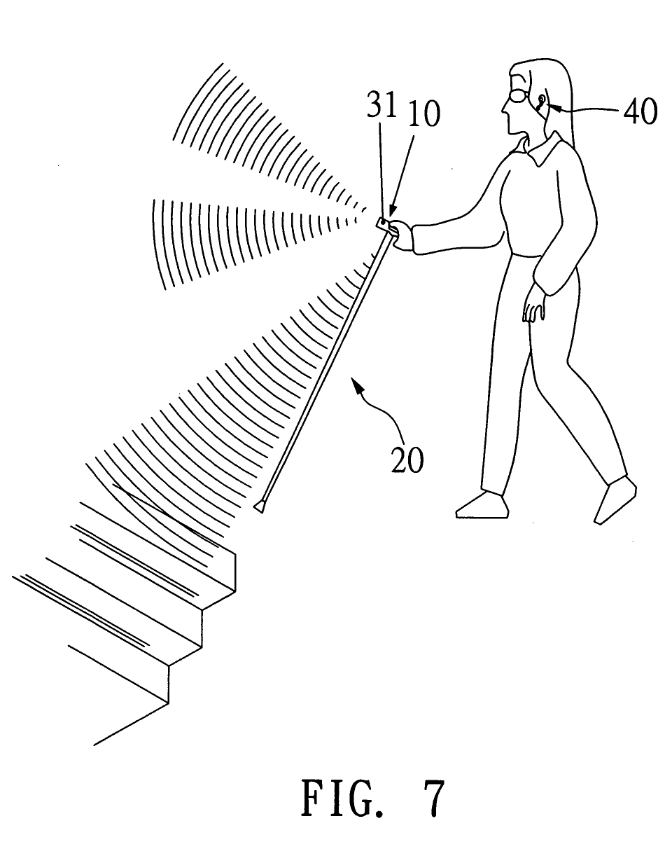

When a blind person uses the blind guidance cane (referring to FIG. 4, FIG. 5, FIG. 6, and FIG. 7), the cordless earphone 40 is first placed onto the ear, the handle 10 is grasped by the hand to turn on the electric eye sensing system 30 power switch 33, the solid sensing electric eyes 31 and the liquid sensing electric eye 32 commence sensor operation; if a solid obstruction (such as stones or stairways, etc.) or a liquid obstruction (such as a water puddle, drainage ditch, or pond, etc.) is encountered within the zone of safety, the solid sensing electric eyes 31 or the liquid sensing electric eye 32 senses and transfers to the signal transceiver 351, which after signal transceiver 351 acknowledgement transfers to the microprocessor 352 such that the voice IC emits a warning sound via the buzzer 354 or the cordless earphone 40; when in close proximity with an obstruction, the emitted warning sound and frequency varies, enabling the blind person to distinguish and, furthermore, have greater warning safety.

When not using the blind guidance cane or entering a crowded space (such as an escalator), the user turns off the electric eye sensing system 30 power switch 33 on the handle 10, thereby disabling the sensor operation and warning sound functions of the electric eye sensing system 30 and preventing unwanted noise.

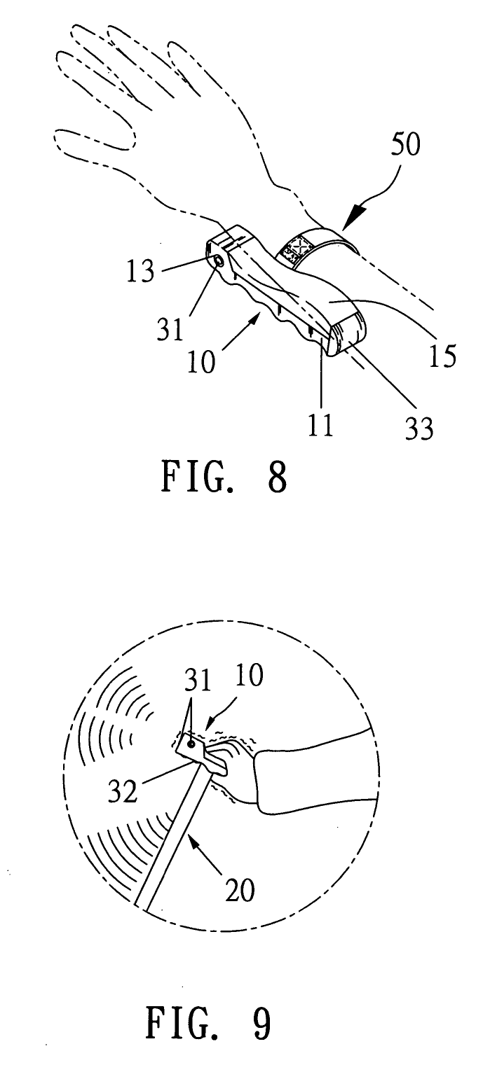

When the user only needs to utilize the blind guidance cane handle 10 (referring to FIG. 8), the cane member 20 threaded stud 22 is unfastened from the handle 10, and the handle 10 can be equipped with an attachment member 50 (such as a hook-and-loop strap) for direct positioning on the wrist to become a portable warning sensor.

When a blind person having impaired hearing utilizes the blind guidance cane (referring to FIG. 9), the handle 10 is grasped by the hand to turn on the electric eye sensing system 30 power switch 33, the solid sensing electric eyes 31 and the liquid sensing electric eye 32 commence sensor operation; if a solid obstruction (such as stones or stairways, etc.) or a liquid obstruction (such as a water puddle, drainage ditch, or pond, etc.) is encountered within the zone of safety, the solid sensing electric eyes 31 or the liquid sensing electric eye 32 senses and transfers to the signal transceiver 351, which after signal transceiver 351 acknowledgement transfers to the microprocessor 352 such that the vibration inductor 36 generates a vibratory warning; when in close proximity with an obstruction, the vibration inductor 36 in the handle 10 generates a vibratory warning that varies in frequency, enabling distinguishability and, furthermore, greater warning safety.

As such, the structure of the said general embodiments is capable of obtaining the following beneficial results: 1) The blind guidance cane has an electric eye sensing system 30, four solid sensing electric eyes 31, and a liquid sensing electric eye 32 disposed in its cane member 20; when a blind person uses the blind guidance cane, the electric eye sensing system 30 is capable of prompting the buzzer 354 or the cordless earphone 40 to emit a warning whenever a solid obstruction or a liquid obstruction is encountered within the zone of safety, enabling greater warning safety. 2) When a blind person uses the blind guidance cane and a solid obstruction (such as stones or stairways, etc.) or a liquid obstruction (such as a water puddle, drainage ditch, or pond, etc.) is encountered within the zone of safety, the solid sensing electric eyes 31 or the liquid sensing electric eye 32 senses and transfers to the signal transceiver 351 such that the buzzer 354 or the cordless earphone 40 emits a warning sound; when in close proximity with an obstruction, the emitted warning sound and frequency varies, enabling the blind person to distinguish with greater safety. 3) When a blind person having impaired hearing utilizes the blind guidance cane and a solid obstruction or a liquid obstruction is encountered within the zone of safety, the solid sensing electric eyes 31 or the liquid sensing electric eye 32 senses and transfers to the signal transceiver 351, and the handle 10 is vibrated by the vibration inductor 36 to generate a vibratory warning; when in close proximity with an obstruction, the vibratory warning varies in frequency, enabling distinguishability and, furthermore, greater safety.

In summation of the foregoing section, since the invention herein is already of an advanced innovative structure that possesses improved original content, while also capable of achieving industrial utility and progressiveness, and thus meets patent law regulations, the present invention is lawfully submitted for patent application to the patent bureau for review and the granting of the commensurate patent rights.

However, the said description only elaborates the most preferred embodiments of the invention herein and shall not be construed as limitation of the scope of the present invention; all modification and embellishments based on the patent application claims of invention herein shall remain proprietary to and protected under the claims of present invention.

1. An electronic blind guidance cane comprised of a handle, a cane member, an electric eye system, and a cordless earphone; the handle body of the said handle consists of a hollow enclosure having a cover attached to the upper extent and the said cane member is a long rod-like construct having a threaded stud at one extremity for the fastening of the said handle, the features of which are:
The said electric eye sensing system consists of four solid sensing electric eyes, a liquid sensing electric eye, a power switch, a battery, and a vibration inductor wired to a printed circuit board, the said printed circuit board having a signal transceiver, a microprocessor, a voice ic, and a buzzer disposed on it; when a solid obstruction or a liquid obstruction is encountered within the zone of safety, the said four solid sensing electric eyes facing different directions or the said liquid sensing electric eye senses and transfers to the said signal transceiver, which after the acknowledgement of the said signal transceiver transfers to the said microprocessor such that the said voice ic emits a warning sound via the said buzzer or the said cordless earphone, or the vibration inductor is prompted by the said microprocessor to generate vibration; and when in close proximity with an obstruction, the outputted warning sound and vibration frequency varies to facilitate the distinguishing of the obstruction.

2. As mentioned in claim 1 of the electronic blind guidance cane of the invention herein, when the user only needs to utilize the said handle of the blind guidance cane, the said handle can be equipped with an attachment member for direct positioning on the wrist to become a portable warning sensor.
